(19) United States
(12) Patent Application Publication
(10) Pub. No.: US 2023/0288606 A1
(43) Pub. Date: Sep. 14, 2023

(54) FLOW SIMULATION IN POROUS MEDIA

(71) Applicant: BP CORPORATION NORTH AMERICA INC., Houston, TX (US)

(72) Inventors: Yuliana M. Zapata Arboleda, Houston, TX (US); Glen L. Gettemy, Katy, TX (US)

(73) Assignee: BP CORPORATION NORTH AMERICA INC., Houston, TX (US)

(21) Appl. No.: 18/181,412

(22) Filed: Mar. 9, 2023

Related U.S. Application Data
(60) Provisional application No. 63/318,661, filed on Mar. 10, 2022.

(51) Int. Cl. G01V 99/00; G06V 20/10; G06V 20/64

(52) U.S. Cl. CPC G01V 99/005; G06V 20/10; G06V 20/64

(57) ABSTRACT

A method for modeling fluid flow within a subterranean formation includes (a) receiving a three-dimensional (3D) image of rock from the subterranean formation. In addition, the method includes (b) defining a chemical system for the subterranean formation, wherein the chemical system comprises a plurality of chemical reactions within the subterranean formation. Further, the method includes (c) determining a concentration change within the subterranean formation over time due to solute transport and the chemical reactions of the chemical system. Still further, the method includes (d) determining a change in pore space within the subterranean formation; and (e) determining an updated concentration within the subterranean formation as a result of the concentration change and the change in pore space.

### CROSS-REFERENCE TO RELATED APPLICATIONS

This application claims the benefit of U.S. Provisional Patent Application Ser. No. 63/318,661 filed Mar. 10, 2022, and entitled “Flow Simulation in Porous Media,” which is hereby incorporated herein by reference in its entirety for all purposes.

### STATEMENT REGARDING FEDERALLY SPONSORED RESEARCH OR DEVELOPMENT

Not applicable.

### BACKGROUND

In various applications, one may wish to understand how fluid flows through and/or within a porous media. Such estimates may be dependent (at least partially) on the specific properties of the porous media and the fluid(s) flowing therein.

For instance, in hydrocarbon exploration and production, the porous media in question may comprise a subterranean rock formation (or more simply “subterranean formations” or “formations”). Obtaining accurate estimates of petrophysical properties of a subterranean formation may thus be important for characterizing the concentration of fluid(s) within the formation over time. Traditionally, samples of the formation, such as from core samples or drilling cuttings, are subjected to physical laboratory tests to measure petrophysical properties such as permeability, porosity, formation factor, elastic moduli, and the like. Once determined, these properties can then be used to make predictions regarding the behavior of the rock formation which may inform a strategy for extracting hydrocarbons or other resources from the formation.

### BRIEF DESCRIPTION OF THE DRAWINGS

For a detailed description of various exemplary embodiments, reference will now be made to the accompanying drawings in which:

FIG. 1 is a block diagram of a method for modeling fluid flow within a subterranean formation according to some embodiments;

FIG. 2 is a schematic view of exemplary onshore and offshore sources of rock samples for analysis by embodiments of testing systems and methods according to some embodiments;

FIG. 3 is a schematic view of an embodiment of a testing system for analyzing rock samples according to some embodiments;

FIG. 4 is an image of a segmented two-dimensional (2D) slice of a three-dimensional (3D) image of a rock sample according to some embodiments;

FIG. 5 is an image of the segmented 2D slice of FIG. 4 after being partitioned according to some embodiments;

FIG. 6 is an image of the segmented and partitioned 2D slice of FIG. 5 after identification of the grain contacts according to some embodiments;

FIG. 7 is a schematic diagram of a three-dimensional (3D) lattice site according to some embodiments;

FIG. 8 is a schematic representation of an application of a modified Lattice-Boltzmann solution for modeling pore-scale fluid transport according to some embodiments; and

FIG. 9 is block diagram of a computer system according to some embodiments.

### DETAILED DESCRIPTION

As previously described, an accurate understanding of fluid flow within a porous media may be dependent upon specific parameters and characteristics of the porous media and fluid(s) contained therein. When the porous media comprises a subterranean formation (e.g., such as in the context of hydrocarbon exploration and production), the properties and behavior of a subterranean formation may be determined via samples of the formation itself. However, due to the cost and time required to directly measure petrophysical properties of rock samples, the technique of “direct numerical simulation” can be applied to efficiently estimate physical properties, such as porosity, absolute permeability, relative permeability, formation factor, elastic moduli, and the like of rock samples, including samples from difficult rock types such as tight gas sands or carbonates. According to this approach, a three-dimensional tomographic image of the rock sample is obtained, for example by way of a computer tomographic (CT) scan. Voxels in the three-dimensional image volume are “segmented” (e.g., by “thresholding” their brightness values or by another approach) to distinguish rock matrix from void space. Direct numerical simulation of fluid flow or other physical behavior such as elasticity or electrical conductivity is then performed, from which porosity, permeability (absolute and/or relative), elastic properties, electrical properties, and the like can be derived. A variety of numerical methods may be applied to solve or approximate the physical equations simulating the appropriate behavior. These methods include the Lattice-Boltzmann, finite element, finite difference, finite volume numerical methods and the like.

Ultimately, as previously described, it is desirable to model the movement of fluid within a subterranean formation. Accurate modeling of such behavior may be relevant for hydrocarbon production operations, and also for other considerations such as contaminant transport and rock diagenesis. The movement of fluid within a subterranean formation is a function of the various petrophysical properties of the rock (e.g., permeability, porosity, formation factor, elastic moduli, etc.), which may be determined as generally described above. In addition, chemical reactions at the fluid-solid interfaces within the formation also contribute to the overall fluid flow behavior within a subterranean rock formation. Attempts at modeling fluid flow within a subterranean rock formation have been made; however, there is a continuing need for improvements in such models, and particularly for models that account for the properties of the rock along with the above-mentioned chemical reactions in a 3D representation of the subterranean formation.

Accordingly, embodiments disclosed herein include systems and methods for modeling fluid flow within a porous media as a function of time. In some embodiments, the porous media comprises a subterranean formation, and the systems and methods described herein utilize digital images of rock samples along with a defined set of chemical reactions at the fluid-solid interfaces in order to generate a model of the fluid flow behavior within a 3D representation of the subterranean formation as a function of time. Thus, through use of the embodiments disclosed herein, more accurate predictions of fluid flow may be made for a porous media (e.g., a subterranean formation), which may further enhance various operations, such as hydrocarbon extraction, environmental mitigation, etc.

In many of the specific embodiments disclosed herein, the porous media comprises a subterranean rock formation. However, it should be appreciated that the term “porous media” may also refer to other types of media that may receive a flow of fluid(s) therein/therethrough. For instance, in some embodiments, the porous media may comprise a filter or catalyst bed that receives a flow of fluid therethrough (e.g., in a chemical processing facility). Thus, while the term “porous media” is intended to include subterranean rock formations, the term should not be interpreted as being limited to subterranean rock formations, and indeed, the term “porous media” may be used broadly to refer to a range of different materials, substances, objects, etc. In addition, the systems and methods disclosed herein may also be applied for characterizing the fluid flow through a non-subterranean rock formation (e.g., such as a fully or partially exposed rock formation that has at least some portion that is not below the ground).

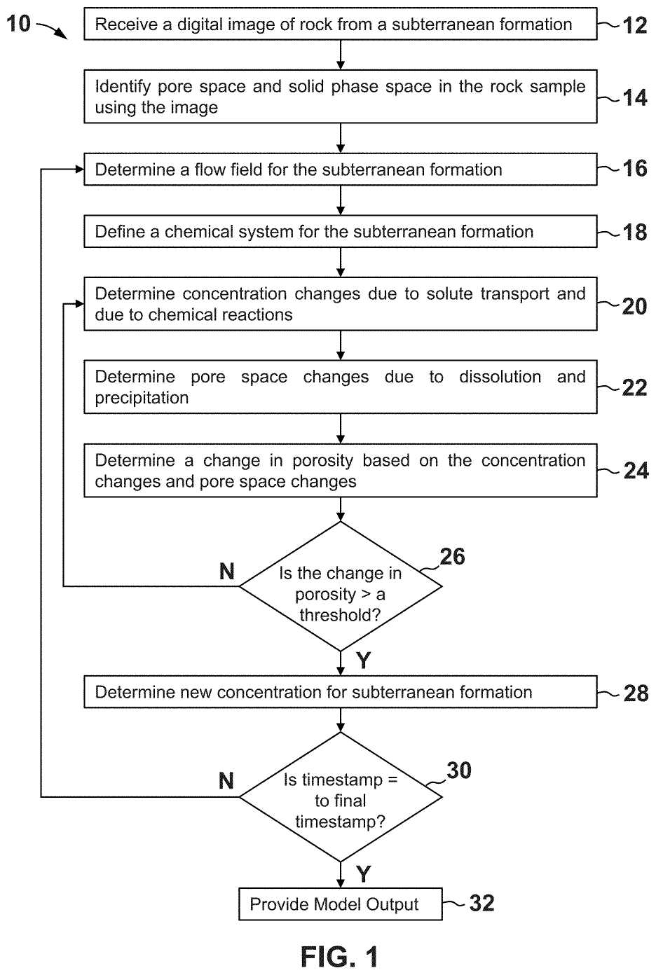

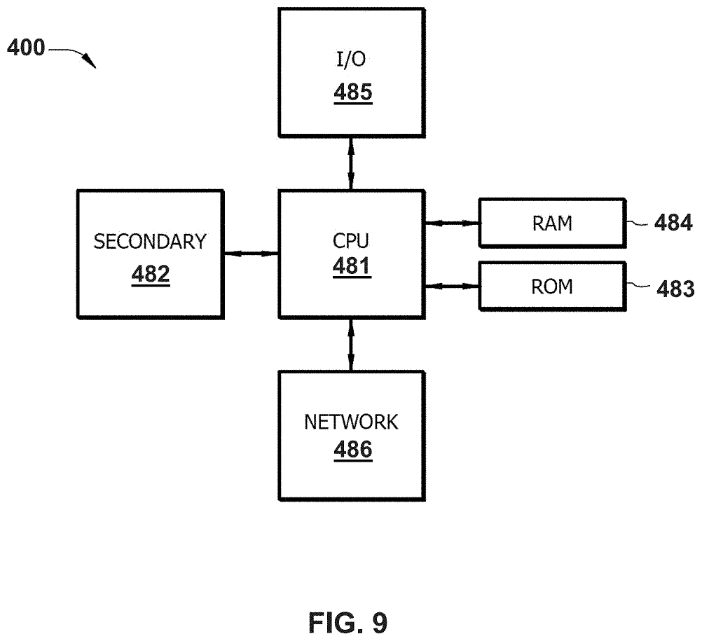

Referring now to FIG. 1, a method 10 for modeling fluid flow within a porous media according to some embodiments is shown. In some embodiments, the porous media may comprise a subterranean formation as previously described. Thus, in the features of method 10 described below, the porous media may be specifically referred to as a “subterranean formation.” In some embodiments, one or more features of method 10 may be performed by, with, or using a computing system or device (or multiple computing devices). The computing device (or devices) may comprise or be similar to the example computing system 400 shown in FIG. 9 and described below.

Initially, method 10 comprises receiving a digital image of rock from a subterranean formation at block 12. For instance, the digital image may comprise a digital image generated from a natural or synthetic rock sample. The rock sample (e.g., a natural rock sample) may comprise a rock sample from a subterranean formation of interest).

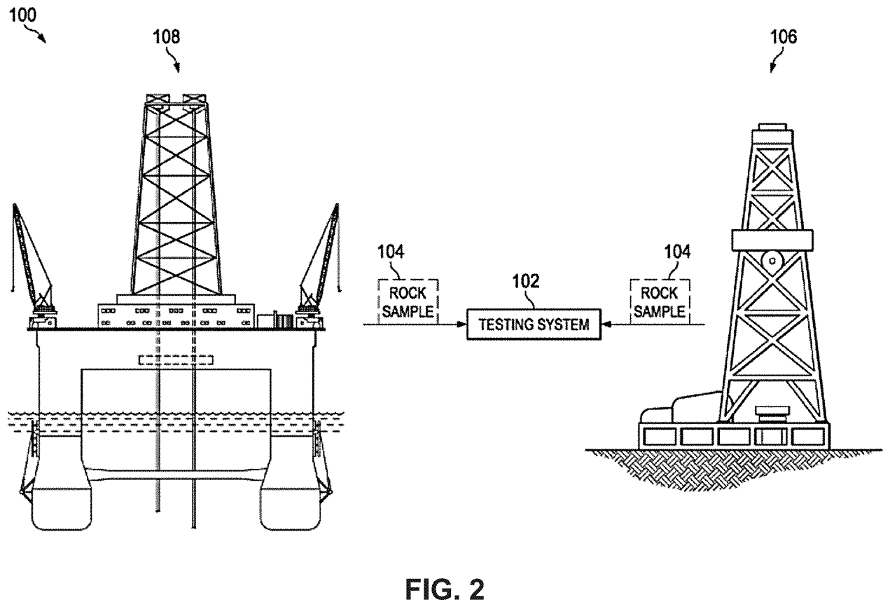

For example, referring now to FIG. 2, a system 100 for acquiring and analyzing rock samples 104 for purposes of generating the digital image in block 12 of method 10 in FIG. 1 is shown according to some embodiments. In some embodiments, system 100 may be used to analyze rock samples 104 that are obtained from a subterranean formation for purposes of enhancing or facilitating oil and gas production from the formation. For example, in some embodiments rock samples 104 can be obtained from terrestrial drilling system 106 or from marine (ocean, sea, lake, etc.) drilling system 108, either of which is utilized to extract resources such as hydrocarbons (oil, natural gas, etc.), water, and the like.

The manner in which rock samples 104 are obtained, and the physical form of those samples, can vary widely. Examples of rock samples 104 useful in connection with embodiments disclosed herein include whole core samples, side wall core samples, outcrop samples, drill cuttings, and laboratory generated synthetic rock samples such as sand packs and cemented packs.

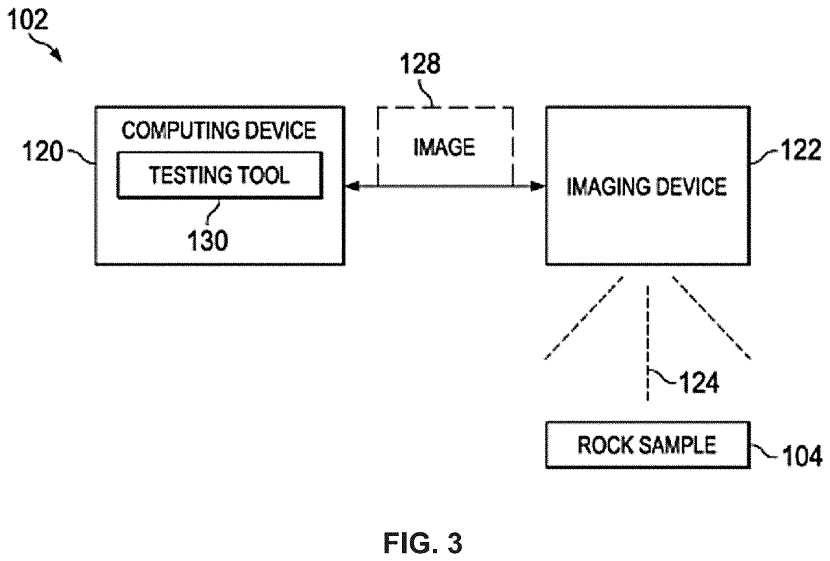

Testing system 102 is configured to acquire and analyze digital images 128 (FIG. 3) of rock samples 104 in order to determine the physical properties of the corresponding sub-surface rock. The physical properties include petrophysical properties, such as those petrophysical properties that are analyzed in the context of oil and gas exploration and production.

Referring now to FIG. 3, a schematic diagram of testing system 102 is shown according to some embodiments. Testing system 102 includes imaging device 122 for obtaining 2D or 3D images, as well as other representations, of rock samples 104, such images and representations including details of the internal structure of the rock samples 104. An example of imaging device 122 is an X-ray CT scanner (or more simply “CT scanner”), which emits x-ray radiation 124 that interacts with an object and measures the attenuation of that x-ray radiation 124 by the object in order to generate an image of its interior structure and constituents. The particular type, construction, or other attributes of CT scanner 122 can correspond to that of any type of x-ray device, such as a micro CT scanner, capable of producing an image representative of the internal structure of rock sample 104. Other embodiments of imaging device 122 may utilize other imaging techniques, such as, for instance X-ray nano-tomography, Focused Ion Beam Scanning Electron Microscopy, Nuclear Magnetic Resonance, etc.

In some embodiments, the digital image volume may be computationally generated rather than produced by scanning the rock samples 104. In embodiments in which the digital image volume is produced by scanning a rock sample 104, the rock sample 104 may be a naturally occurring rock or a man-made porous material (e.g., a synthetic rock).

The image 128 may be in the form of grayscale values representative of the attenuation of the x-ray radiation by the constituents of rock sample 104. The 3D digital image volume 128 of rock sample 104 may comprise multiple 2D slice images at locations stepped along one axis of rock sample 104, which together form the 3D image 128 of rock sample 104. In general, the combining of the 2D slice images into 3D digital image volume 128 may be performed by computational resources within imaging device 122 itself, or by a computing device 120 from the series of 2D slice images 128 produced by imaging device 122, depending on the particular architecture of testing system 102. The computing device 120 may comprise or be similar to the computing system 400 shown in FIG. 9.

The images produced by imaging device 122 may be partitioned into 3D regular elements called volume elements, or more commonly “voxels”. In general, each voxel is cubic, having a side of equal length in the x, y, and z directions. Digital image volume 128 itself, on the other hand, may contain different numbers of voxels in the x, y, and z directions. Each voxel within a digital volume has an associated numeric value, or amplitude, that represents the relative material properties of the imaged sample at that location of the medium represented by the digital volume. The range of these numeric values, commonly known as the grayscale range, depends on the type of digital volume, the granularity of the values (e.g., 8 bit or 16 bit values), and the like. For example, 16 bit data values enable the voxels of an x-ray tomographic image volume to have amplitudes ranging from 0 to 65,536 with a granularity of 1. The images 128 captured by the imaging device 122 may comprise the digital images received at block 12 of method 10.

Referring again to FIG. 1, method 10 includes, at block 14, identifying pore space and solid phase space in the rock sample using the digital image (e.g., the digital image obtained at block 12). In some embodiments, the pore spaces and solid phase spaces may be identified at block 14 by segmenting the 3D image into a plurality of 2D slices, partitioning the segmented 3D image to identify contacts between component grains, and determining the number and the size of the contacts between the components grains from the partitioned, segmented 3D image.

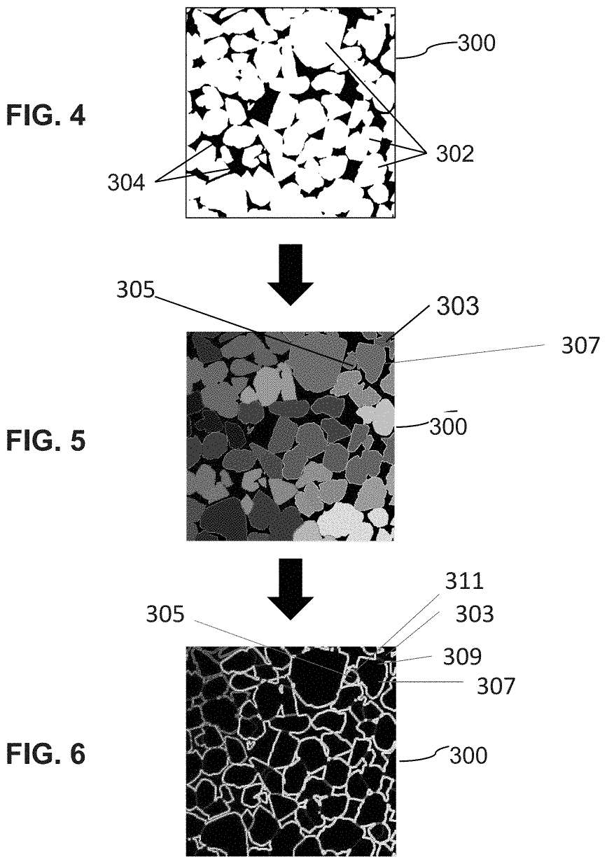

Referring now to FIGS. 3 and 4, an example of an image 300 of one segmented 2D slice of digital image volume 128 of rock sample 104 is shown. The segmented 2D slice image 300 illustrates a cross-sectional slice of the structural details of rock sample 104, including the features of solid material 302 such as individual grains of rock (shown in white in FIG. 4) and pore or void space 304 (shown in black in FIG. 4). In some embodiments, the testing system 102 performs segmentation or other image enhancement techniques on digital image volume 128 of rock sample 104 to distinguish and label different components or phases of image volume 128 from the grayscale values of the image. The segmented digital image volume 128 may comprise a 2D slice image 300 that represents the rock sample 104. More specifically, computing device 120 may perform this segmentation to identify components, such as pore space and mineralogical components (e.g., clays and quartz). In some embodiments, testing tool 130 is configured to segment the image volume 128 into more than two significant phases, representing such material constituents as pore space, clay fraction, quartz fraction, and other various mineral types.

The computing device 120 may utilize any of a number of types of segmentation techniques. One approach to segmentation is the application of a “thresholding” process to image volume 128, in which computing device 120 chooses a threshold value within the voxel amplitude range. Those voxels having an amplitude below the threshold value are assigned one specific numeric value that denotes pore space, while those voxels having an amplitude above the threshold are assigned another numeric value that denotes matrix space (i.e., solid material). In this approach, thresholding converts a grayscale image volume to a segmented volume of voxels having one of two possible numeric values, commonly selected to be 0 and 1. FIG. 4 illustrates an example of the segmentation performed on the slice image 300 of a 3D digital image volume 128 via thresholding. As illustrated, segmentation allows the structural details of a rock sample to be distinguished, in this example with the solid material 302 shown in different colors (various shades 40 of gray in the grayscale image of FIG. 4) representative of different materials in the volume 128, and pores or void space 304 shown in black. Further segmentation can be applied one or more times to differentiate various features within the image. If simple thresholding is used, multiple threshold values can distinguish among different materials exhibiting different x-ray attenuation characteristics, such as clay, quartz, feldspar, etc.

Computing device 120 may utilize other segmentation techniques. For instance, in some embodiments computing device 120 may utilize Otsu's Method, in which a histogram-based thresholding technique selects a threshold to minimize the combined variance of the lobes of a bimodal distribution of grayscale values (i.e., the “intra-class variance”). Otsu's method can be readily automated and may also be extended to repeatedly threshold the image multiple times to distinguish additional material components such as quartz, clay, and feldspar. Other examples of automated segmentation techniques of varying complexity may alternatively or additionally be used by computing device 120 to distinguish different features of an image volume, such techniques including Indicator Kriging, Converging Active Contours, Watershedding, and the like.

The computing device 120 may also utilize other image enhancement techniques to enhance or improve the structure defined in image volume 128 to further differentiate among structure, to reduce noise effects, and the like. Likewise, while computing device 120 can perform the segmentation or other image enhancement techniques, it is contemplated that other components of testing system 102, for example imaging device 122 itself, may alternatively perform image enhancement in whole or in part. Segmentation associates the voxels in the digital image volume with the particular material (or pore space, as the case may be) at the corresponding location within rock sample 104. Some or all of the voxels may be labeled with one or more material properties corresponding to the particular material constituent assigned to that voxel. Such constituents including pore space, matrix material, clay fraction, individual grains, grain contacts, mineral types, and the like.

In some embodiments, the computing device 120 may partition the identified phases of the segmented digital image volume 128 to identify the individual contacts or contact interfaces between the component grains. Partitioning can be performed with imaging software such as Avizo™ Software available from ThermoFisher Scientific™ of Hillsboro, Oreg., USA. During partitioning, each component grain may be identified in terms of voxels (e.g., voxels 303, 305, 307, as shown in FIG. 5) in the 2D slice image 300. That is, each voxel or group of voxels define or represent a single grain, and the voxels of each grain may be represented by a different colored (or patterns, shades of grey) voxel or group of voxels as shown on FIG. 5. FIG. 5 illustrates an example of a partitioned 2D slice image 300 of a 3D image (e.g., digital image volume 128) of a rock sample, which shows a cross-sectional slice of the structural details of that rock sample. The size (e.g., area, volume, radius, etc.) of each grain may be determined via imaging software. After partitioning, contacts between grains (e.g., interfaces 309, 311, as shown on FIG. 6) are identified as an area where a voxel belonging to a grain x (e.g., voxel 303), is adjacent to a voxel belonging to a grain y (e.g., voxel 305).

After partitioning, computing device 120 may then identify the contact interfaces between the grains (e.g., interfaces 309, 311, as shown on FIG. 6) and determine (e.g., calculates) the contact area (also referred to simply as “area”) of each contact interface. The contact interfaces are identified by adjacent grain voxels. For example, a contact interface between two grains may be defined by a group or clump of adjacent voxels between two adjacent grains. Thus, by identifying the groups of voxels between adjacent grains, the contact interfaces between the grains can be identified. Once the contact interfaces between the grains are identified, the boundaries of the contact interfaces are known and can be used to determine (e.g., calculate) the contact area of each contact interface. The area of a contact between two voxels is the area of one of the voxel sides at the interface (e.g., a voxel is a cube). For example, if a two contacting grains each have 100 adjacent voxels and the area of a voxel side is 4 microns², the total contact area for the two grains is 400 microns².

Referring again to FIG. 1, method 10 includes, at block 16, identifying a flow field for the subterranean formation. In some embodiments, identifying the flow field for the subterranean formation comprises determining a distribution of pressure and fluid flow velocity within the subterranean formation at a particular time stamp (e.g., an initial time stamp or a subsequent time stamp). In some embodiments, the distribution of pressure and fluid flow velocity may be computed using a Lattice-Boltzmann based steady-state solution. The Lattice Boltzmann method is a temporally and spatially discrete solution to the Boltzmann equation that describes fluid flow and can fully recover the Navier-Stokes characterization of fluid behavior at the continuum scale. During this analysis, the fluid is modeled as a collection of discrete particles moving through a discretized regular lattice. In this lattice, the fluid is represented in terms of the probability of finding average populations of particles at a given time and position, with a certain velocity.

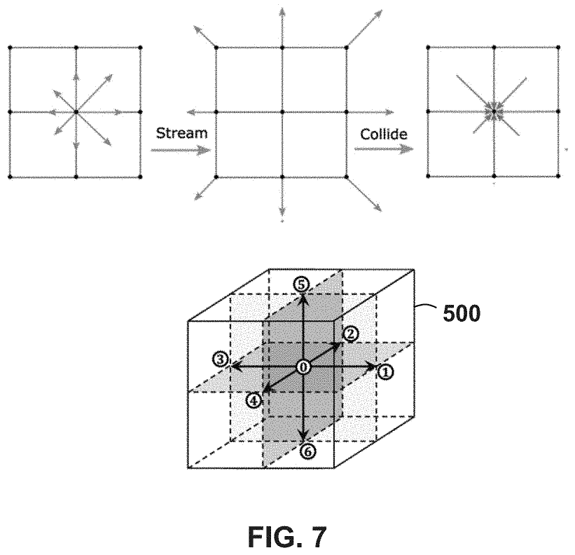

The particle movement through the lattice may be defined by a two-stage process occurring at each time step: streaming and collision. The streaming stage refers to the advection of the particle to its next location (lattice site), and the collision stage represents the interaction of the particle with other particles occupying this new location. Additionally, at each site it is assumed that the particles are limited to movement along a finite number of directions and the particle velocities are restricted to a specific number of discrete values. Both the model dimensions and the number of directions the particle is allowed to move in each site determine the type of lattice. FIG. 7 shows an example of a three-dimensional (3D) lattice site 500 that indicates various possible directions of movement for a particle therein (e.g., vectors (1)-(6) and a non-movement position (0)). This approach provides information on the macroscopic fluid properties, taking into consideration microscopic interactions and allowing the simulation of complex geometries and surface configurations. Moreover, simple and efficient parallel computation can be implemented using this methodology.

In some embodiments, method 10 is performed for a 3D representation (e.g., a 3D digital representation) of the subterranean formation. Thus, as previously alluded to above, the flow field identified in block 16 may comprise a 3D flow field that accounts for the distribution of pressure and fluid velocity along three orthogonal directions (e.g., x, y, and z) within the 3D representation of the subterranean formation.

Method 10 also include determining a chemical system for the subterranean formation at block 18. The chemical system may comprise a collection of chemical reactions that are anticipated within the subterranean formation based on the chemical species disposed therein. The chemical reactions may comprise chemical reactions that may occur at the solid/fluid interfaces (e.g., such as the reactions that occur between the fluids present in the pore space and solid chemical and/or mineral species that are present within the subterranean formation).

The chemical reactions at block 18 may comprise chemical reactions that are expected between the aqueous phase species within the subterranean formation and chemical reactions expected between the aqueous phase and mineral phase species within the formation. The chemical reactions between the aqueous phase species may be referred to here as “homogenous chemical reactions” and the chemical reactions between the aqueous and mineral phase species may be referred to herein as “heterogenous chemical reactions.”

In some embodiments, individual chemical species may be classified into primary species and secondary species that are then lumped into components to facilitate the reduction of the number of equations (e.g., chemical equations) utilized to solve for a species concentration. The number of primary species is given by the difference between the total number of species involved in the chemical reactions and the number of reactions. The selection of the primary species within a chemical system may be arbitrary in some circumstances. Among the considerations for the selection of the primary species are ensuring that: (1) the selected primary species are independent of each other; and (2) the selected primary species are part of the reaction expressions that can be eliminated from the system by reduction. In some embodiments, the number of secondary species is set to be equal to the number of reactions.

To further illustrate the description above, an example of a simplified chemical system to model carbonate precipitation/dissolution is considered. This example system may include the following chemical reactions in Equations (1)-(4):

CaCO₃↔Ca⁺²+CO₃⁻² Equation (1);

HCO₃⁻↔H⁺+CO₃⁻² Equation (2);

H₂CO₃↔2H⁺+CO₃⁻² Equation (3); and

H₂O↔H⁺+OH⁻ Equation (4).

Equation (1) is a heterogeneous chemical reaction, and Equations (2), (3), and (4) are homogeneous chemical reactions. The chemical reactions defined by Equations (1)-(4) may provide primary species of H⁺, CO₃⁻², and Ca⁺², and secondary species of OH⁻, H₂CO₃, HCO₃⁻, and CaCO₃. In addition, Table 1 below presents the chemical reactions in a matrix form in terms of primary and secondary species written as a function of the lumped components.

TABLE 1

| Species | | | |
|---|---|---|---|
| Primary/ | Lumped Components | | |
| Secondary | TOT H⁺ | TOT Ca⁺² | TOT CO₃⁻² |
| CaCO₃ | | 1 | 1 |
| HCO₃⁻ | 1 | | 1 |
| H₂CO₃⁻ | 2 | | 1 |
| OH⁻ | −1 | | |
| H⁺ | 1 | | |
| Ca⁺² | | 1 | |
| CO₃⁻² | | | 1 |

Thus, the chemical system may be solved for the following lumped chemical components in based on the primary and second species noted above:

C_{H}_{⁺}=TOT H⁺=[H⁺]−[OH⁻]+2[H₂CO₃]+[HCO₃⁻];

C_{CO}_{₃}_{^{−2}}=TOT CO₃⁻²=[CO₃⁻²]+[H₂CO₃]+[HCO₃⁻]+[CaCO₃]; and

C_{Ca}_{⁺²}=TOT Ca⁺²=[Ca⁺²]+[CaCO₃].

More specifically, the chemical system may be solved for the above-noted lumped chemical components (TOT H⁺, TOT CO₃⁻, and TOT Ca⁺²) rather than between the individual chemical species within the subterranean formation. Without being limited by this or any other theory, lumping the chemical species may reduce the number of chemical reactions that may be considered at block 18, and thus may simplify the method 10 (e.g., to reduce the amount of computing power for carrying out the features of method 10).

In some embodiments, the type of reactions occurring within the subterranean formation depend not only on temperature and pressure conditions but also on the mineral composition of the formation and the characteristics of the fluid occupying the pore space such as its aqueous composition, ion solubility and concentration. Several chemical reactions may be occurring simultaneously inside the subterranean formation, therefore the system of reactions considered for a given formation may be complex. However, consideration may be limited to reactions having a significant effect on the pore space changes (reactions that result in precipitation or dissolution of material) or that impact the system in the time frame, pressure and temperature conditions of interest. In an effort to provide additional specific examples, Table 2 (shown below) includes some common reactions occurring in different subterranean formations such as sandstones, carbonates and mudrocks.

TABLE 2

| Process | Reaction | Temperature (° C.) |
|---|---|---|
| Quartz precipitation | H₄SiO₄ → SiO₂ + 2H₂O | >80 |
| Calcite precipitation | Ca²⁺ + CO₂ + H₂O → CaCO₃ + 2H⁺ | 100-160 |
| Albitization | Na⁺ + 3H⁴SiO⁴ + Al³⁺ → NaAlSi₃O₈ + 4H⁺ + 4H₂O | 75-200+ |
| | KAlSi₃O₈ + Na⁺ → K⁺ NaAlSi₃O₈ | |
| Pyrite precipitation | Fe²⁺ + 2H₂S → FeS₂ + 4H⁺ | — |
| K-feldspar and Kaolinite | KAlSi₃O₈ + Al₂Si₂O₈(OH)₄ → | 50-120 |
| conversion | muscovite/illite + 2SiO₂ + H₂O | |
| Organic matter | CH₂O + H₂O → CO² + 4H⁺ | 40-100 |
| Smectite to illite conversion | smectite + Al³⁺ + K⁺ → illite + Si⁺⁴ | 60-100 |
| K-feldspar dissolution | KAlSi₃O₈ + 4H⁺ + 4H₂O → K⁺ + Al³⁺ + 3H₄SiO₄ | 80-160 |
| Carbonate dissolution | CaCO₃ + H⁺ → Ca²⁺ + HCO₃⁻ | >60 |
| Dolomite dissolution | CaMg(CO₃)₂ + 2H⁺ → Ca²⁺ + Mg²⁺ + 2HCO₃⁻ | 25-150 |
| Dedolomitization | CaMg(CO₃)₂ + CaSO₄ → 2CaCO₃ + MgSO₄ | <50 |
| Dolomitization | 2CaCO₃ + Mg²⁺ → CaMg(CO₃)₂ + Ca⁺ | 70-110 |

Referring still to FIG. 1, method 10 also includes determining concentration changes in the subterranean formation due to solute transport and due to chemical reactions at block 20. The concentration changes may comprise changes in the concentration of fluids and solids within the subterranean formation. The concentration changes may be driven by both physical movement of fluids within the formation (e.g., solute transport) and by chemical reactions within the subterranean formation (e.g., both homogeneous and heterogenous reactions). The concentration changes in the subterranean formation due to solute transport may be determined separately from the concentrations in the subterranean formation due to chemical reactions. Alternatively, the concentration changes due to both solute transport and chemical reactions may be determined in a combined sequence.

In some embodiments, the changes in concentration due to solute transport may be analyzed by considering solute transport due to both advection and diffusion of the fluids within the subterranean formation. Advection refers to the movement of heat or matter due to fluid flow within a medium. Within a subterranean formation, fluid may be flowing due to pressure gradients present therein. Diffusion refers to the movement of a fluid or substance within a medium (e.g., a subterranean formation) from areas of high concentration to areas of lower concentration. Over time, both advection and diffusion may drive movement of the solute within the subterranean formation due to pressure and concentration gradients present within the formation.

In some embodiments, the concentration changes due to chemical reactions may describe the interactions of components within the aqueous phase and between the fluid and the solid (or mineral) phases within the subterranean formation. The chemical reactions may comprise the collection of chemical reactions identified in block 18.

In some embodiments, the concentration changes in the subterranean formation may be determined at block 20 according to Equation (5):

$$\frac{\partial {C}_{k}}{\partial t} = - ( u \cdot ∇ ) {C}_{k} + ∇ \cdot ( D \cdot ∇ {C}_{k} ) + {Σ}_{m} {A}_{m} {l}_{m} \qquad Equation ( 5 )$$

where Cₖ is the concentration of the particular solute component (k), t is time, u is the flow rate, and D is the diffusion coefficient, Aₘ is the surface area of the solid/mineral phase available for reaction and Iₘ is the mineral reaction rate. In addition, in Equation (5) ∇ can represent a number of different operators. For instance, for the term ∇Cₖ, ∇ represents the gradient of the concentration of species k (the rate of change in concentration in each direction) according to the following expression (Equation (6)):

$$∇ {C}_{k} = \frac{\partial {C}_{k}}{\partial x} + \frac{\partial {C}_{k}}{\partial y} + \frac{\partial {C}_{k}}{\partial z} . \qquad Equation ( 6 )$$

Conversely in the term (u·∇)Cₖ in Equation (5), ∇ represents the rate of change in concentration but multiplied by the velocity in that direction according to the following expression (Equation (7)):

$$( u \cdot ∇ ) {C}_{k} = {u}_{x} \frac{\partial {C}_{k}}{\partial x} + {u}_{y} \frac{\partial {C}_{k}}{\partial y} + {u}_{z} \frac{\partial {C}_{k}}{\partial z} . \qquad Equation ( 7 )$$

Thus, within Equation (5) the expression “(u·∇)Cₖ” represents the concentration changes in the subterranean formation due to advection-based solute movement, the expression “∇·(D·∇Cₖ)” represents the concentration changes in the subterranean formation due to diffusion-based solute movement, and the expression “ΣₘAₘlₘ” represents the concentration changes in the subterranean formation due to chemical reactions.

In some embodiments, Equation (5) can be solved in block 20 using a multi-component reactive transport model at the pore-scale. In some embodiments, the model combines a steady state Lattice-Boltzmann based algorithm to simulate flow, with a modified Lattice-Boltzmann solution that accounts for transport in terms of advection and diffusion, a kinetic treatment of heterogeneous reactions by implementing boundary conditions at the solid fluid interface, and an iterative approach to update the pore space and flow field as a solute concentration evolves over time.

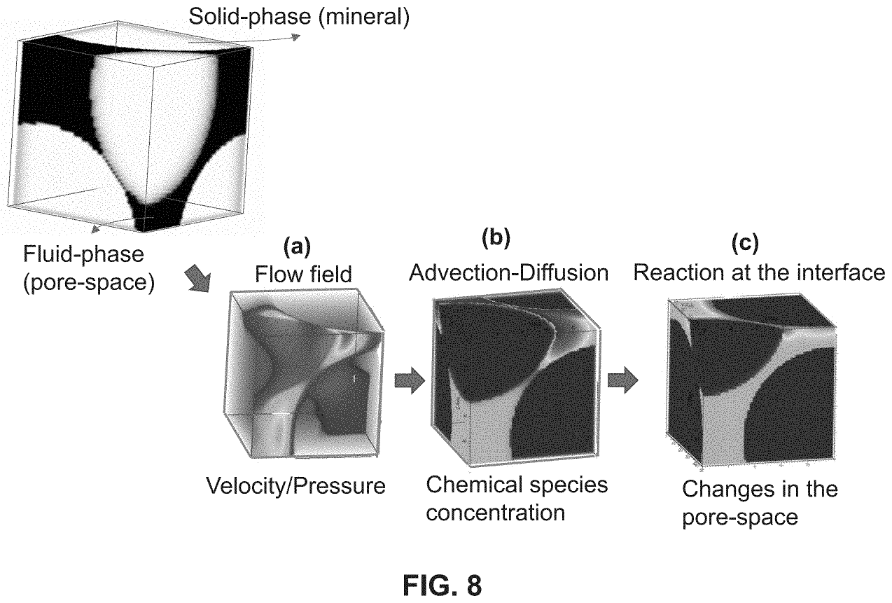

Specifically, in some embodiments, Equation (5) can be solved in block 20 using a modified Lattice-Boltzmann solution that recovers pore-scale fluid transport in terms of advection and diffusion, with a reactive component that accounts for homogeneous reactions assumed to be in a local thermodynamic equilibrium and heterogeneous reactions treated kinetically. Reference is now made to FIG. 8 which depicts an application of a modified Lattice-Boltzmann solution as described above. The modified Lattice-Boltzmann solution may use the flow field obtained from the single-phase Lattice-Boltzmann based algorithm as an input. For instance, the input to the modified Lattice-Boltzmann solution may comprise a flow field that is similar to the flow field determined for block 16 of FIG. 1. An example of the flow field input to the modified Lattice-Boltzmann solution is also shown in part (a) of FIG. 8 according to some embodiments. Unlike the single-phase Lattice-Boltzmann solution, the modified Lattice-Boltzmann solution provides information about the concentration changes for a given k^{th} chemical component (not the velocity field) in terms of a distribution function (G). The general form of the modified distribution function is shown in Equation (8) below.

$${G}_{α k} ( x + {e}_{α} δ t , t + δ t ) = {G}_{α k} ( x , t ) - \frac{{G}_{α k} ( x , t ) - {G}_{α k}^{eq} ( {C}_{k} , u )}{{τ}_{aq}} . \qquad Equation ( 8 )$$

In Equation (8) above, Gₐₖ is the distribution function in an a direction in the velocity space for the k^{th} component, δt is the time increment, eₐ are the velocity vectors, Gₐₖ^{eq} is the equilibrium distribution function, u is the velocity, Cₖ is the concentration of the k^{th} component, and τ_{aq} is the dimensionless relaxation time. The equilibrium distribution function, velocity vectors, and relaxation time are dependent on the lattice model (e.g., it is a function of the lattice dimensions and the number of lattice velocities). For a three-dimensional nine-velocity lattice (D3Q9), the form of the equilibrium distribution function is shown in Equation (9), and the relaxation time in Equation (10), below.

$${G}_{α k}^{eq} ( {C}_{k} , u ) = ( 1 + \frac{{e}_{α} u}{{e}_{s}^{2}} + \frac{{e}_{α} {e}_{α} : uu}{2 {e}_{s}^{4}} - \frac{u \cdot u}{{e}_{s}^{2}} ) {ω}_{α} {C}_{k} ( x , t ) . \qquad Equation ( 9 )$$

$${τ}_{aq} = \frac{1}{2} \partial t + \frac{D}{{e}_{s}^{2}} . \qquad Equation ( 10 )$$

In Equation (9) and Equation (10), eₛ is the pseudo lattice speed of sound and ωₐ are weight coefficients, both parameters depend on the lattice type. In addition, in Equation (9) and Equation (10), D is the diffusion coefficient.

The number of distribution functions utilized to capture the concentration changes in each voxel of a 3D representation of the subterranean formation is given by the number of lattice velocities and the chemical species involved in the system as previously described (block 18 in FIG. 1). Once the distribution functions are calculated for every lattice velocity and component, the concentration of a given k^{th} component (Cₖ) can be estimated through the summation of the distribution functions over all discrete velocities as in Equation (11) below. Part (b) of FIG. 8 shows an example of the concentration distribution for a given component k^{th}.

Cₖ=ΣₐGₐₖ Equation (11).

As mentioned above, the reactive component of Equation (5) accounts for homogeneous and heterogeneous reactions. Homogeneous reactions are characterized based on the assumption of local thermodynamic equilibrium and using the mass action law as shown in Equation (12). On the other hand, heterogeneous reactions are kinetically treated by implementing boundary conditions at the solid-fluid interface that consider the reaction rates of the chemical species of interest as shown in Equation (13). A general form of boundary conditions applied at the interface to account for heterogeneous reactions is shown in Equation (13).

$${C}_{i} = {( {γ}_{i} )}^{- 1} {K}_{i} {\prod }_{j = 1}^{{N}_{C}} {( {γ}_{j} {C}_{j} )}^{{v}_{ji}} \qquad Equation ( 12 )$$

$$D \frac{\partial {Ψ}_{k}}{\partial n} = {\sum }_{m = 1}^{{N}_{m}} {v}_{km} {I}_{m}^{*} . \qquad Equation ( 13 )$$

Within Equation (12) the primary species (Cⱼ) and secondary species concentrations (Cᵢ), are related as a function of the number of independent species associated to primary species (N_{c}) using the stoichiometric coefficients of homogeneous reactions (vⱼᵢ), the activity coefficients (yⱼ and yᵢ) and the equilibrium constant (Kᵢ).

Within Equation (13), n represents the direction normal to the solid/fluid surface, vₖₘ is the stoichiometric coefficient of the reaction, Nₘ is the number of reactive minerals (number of heterogeneous reactions), and I*ₘ is the reaction rate of the mineral or solid phase which is dependent on the concentration. Part (c) of FIG. 8 shows an example of the changes at the solid/liquid interface resulting after the above-noted homogeneous and heterogeneous reactions take place.

As previously described, in some embodiments, the method 10 is performed for a 3D representation of the subterranean formation. Thus, in some embodiments, the changes in concentration at block 20 may be determined along three orthogonal directions (e.g., x, y, and z).

Referring still to FIG. 1, method 10 also includes determining pore space changes due to dissolution and precipitation at block 22. Dissolution refers to the process whereby solid (or mineral) phase materials within the subterranean formation dissolve into the fluid species, while precipitation refers to the opposite process whereby minerals that are dissolved within the fluids of the subterranean formation combine to form solid minerals that may bind to the solid (or mineral) phase materials therein. Dissolution and precipitation may occur at the fluid/solid boundaries within the subterranean formation, so that these processes may change the available pore space within the subterranean formation.

In some embodiments, the occurrence of dissolution or precipitation of a given mineral is determined as a function of the saturation index (SI) for each discretized space in the system. The SI provides information about how far the reaction is from equilibrium and may be described by Equation (14) below. When the SI is greater than zero (e.g., SI>0) the solution is supersaturated, thereby indicating that mineral precipitation is occurring. If the SI is less than zero (e.g., SI<0), then the solution is undersaturated with respect to the mineral, thereby indicating that dissolution is occurring.

$$SI = log ( \frac{IAP}{{K}_{eq}} ) \qquad Equation ( 14 )$$

In Equation (14), IAP is the ion product activity and Keg is the equilibrium constant at a given temperature. IAP is the product of the chemical species concentrations corrected by the activity coefficient, and it is calculated using the concentration distributions obtained in block 20. IAP represents a real measurement of the species concentrations in comparison with the concentrations at equilibrium state used in the calculation of the equilibrium constant.

Because the method 10 may be performed for a 3D representation of the subterranean formation, the pore space changes determined at block 22 may be computed in a 3D space (and therefore along three orthogonal directions). Accordingly, block 22 may comprise determining changes in 3D surfaces that represent the fluid-solid boundaries within the 3D representation of the subterranean formation. These 3D surfaces are positioned along particular voxels of the 3D representation of the subterranean formation. Precipitation and dissolution processes occur along these 3D surfaces where the minerals (solid phase) and fluids (liquid phase) are in contact. The associated changes in pore space due to solid/fluid interaction give these 3D surfaces a dynamic nature.

After the chemical species concentrations are updated in each time step the 3D surface can be updated if significant changes occurred in the pore space. To update the 3D surface, the voxels included in the surface at a given time are considered control volumes. An initial volume is assigned to each interface voxel and changes in the volume are tracked at each time step. The precipitation/dissolution is governed by the SI as shown in Equation (14), and the volume change is tracked as shown in Equation (15). If the volume of a solid voxel zero (e.g., Vₘ=0), the voxel is converted into a fluid voxel (dissolution), if the volume associated with a fluid voxel becomes larger that a threshold (e.g., Vₘ>V_{threshold}) the voxel is converted to a solid voxel (e.g., comprising solid phase mineral(s)).

Vₘ(t+δt)=Vₘ(t)+V̅ₘ̅aₘI*ₘδt Equation (15)

In Equation (15), Vₘ is the associated volume of a given voxel, δt is the time change, aₘ is the surface area of the mineral available for interaction with the fluid (solid phase surface area), and Iₘ is the reaction rate.

Next, in block 24, method 10 includes determining a change in the porosity of the subterranean formation based on the concentration changes and the pore space changes. The changes in the concentration may comprise the changes in concentration due to solute transport and chemical reactions determined at block 20. In addition, the changes in the pore space may be determined via the dissolution and precipitation within the subterranean formation at block 22. In some embodiments, the change in porosity may be determined as a part of the analysis of block 20.

Referring still to FIG. 1, after the change in porosity is determined at block 24, method 10 includes determining whether the change in porosity is greater than a threshold at block 26. Without being limited to this or any other theory, performing the computations and analysis of method 10 may involve use of considerable amounts of computing power. The use of such resources may carry considerable costs. Thus, the threshold at block 26 may be selected so as to ensure that computing resources are utilized most efficiently and to display meaningful change in porosity and fluid concentration in a subterranean formation over time. In some embodiments, the porosity threshold is a dynamic value that represents the percentage of change in pore space that will have a significant impact on the pressure/velocity field, resulting in variations in permeability and flow patterns. In some embodiments, the porosity threshold may capture relevant topologic variations in the system without increasing the computational load due to recalculation of the pressure/velocity fields at each step. In some embodiments, the porosity threshold may comprise a 10% or less change in the porosity within a given time period.

If the change in porosity is greater than the threshold at block 26, method 10 may progress on to block 28. Conversely, if the change in porosity is less than or equal to the threshold at block 26, the method 10 may recycle back to block 20 to redetermine the concentration changes within the subterranean formation. Without being limited to this or any other theory, if the porosity change at block 26 is below or equal to the threshold, then the method may compute a further change in porosity for an additional unit or period of time (e.g., another time stamp) via blocks 20-24 as previously described. In this manner, method 10 may progress forward from block 26 with a meaningful change in porosity so that computing time and power may be reduced.

In some embodiments, thresholds may be applied to other parameters either in addition to or in lieu of the porosity change in blocks 24 and 26. For instance, in some embodiments, block 24 may comprise determining a change in mass and/or a change in a chemical component proportion, and block 26 may comprise determining whether the parameter (or change therein) is above or below a designated threshold (which can be a dynamic threshold as described above for the porosity change).

If the porosity change at block 26 is greater than the threshold, method 10 progresses to block 28 to determine a new concentration for the subterranean formation based on the change in porosity at block 28 as well as the concentration changes at block 20 and the pore space changes at block 22. At block 28 the concentration may be calculated for each of the chemical species present in the system based on concentrations obtained in block 20. Both primary and secondary species concentrations may be computed by solving the linear system of equations that results from the lumped component and equilibrium definitions stated in block 18. These updated concentrations can then be used as input for the following time stamp.

At block 30, method includes determining whether the current time stamp is equal to the final time stamp. At the initiation of method 10, a finite number of time stamps may be determined. The time stamps may correspond to the period of time (e.g., a period of days, months, years, etc.) that are being considered for the subterranean formation. Thus, the number of time stamps may vary widely for each performance of method. However, if blocks 16-28 have been performed for the predetermined number of time stamps at block 30, the determination may be “yes,” so that method 10 may progress to block 32 in which the final model output is provided. If, on the other and, the time stamp at block 30 is not the final time stamp, the determination at block 30 may be “no” so that the method 10 may recycle back to block 16 to initiate performance of blocks 16-28 for an additional time stamp.

The model output at block 32 may comprise a plurality of concentration computations at a plurality of time stamps. Thus, the model output may show a prediction of a progression or change in material concentrations within the 3D representation of the subterranean formation over a period of time (e.g., at a plurality of discrete time stamps). Such a prediction would be useful for predicting the movement of fluid within the subterranean formation during mineral (e.g., hydrocarbon) extraction operations or for other operations (e.g., contaminant tracking operations).

The embodiments disclosed herein include systems and methods for modeling fluid flow within a subterranean formation as a function of time. In some embodiments, the systems and methods described herein utilize digital images of rock samples along with a defined set of chemical reactions at the fluid-solid interfaces in order to generate a model of the fluid flow behavior within a 3D representation of the subterranean formation as a function of time. Thus, through use of the embodiments disclosed herein, more accurate predictions of fluid flow may be made for a subterranean formation, which may further enhance various operations, such as hydrocarbon extraction, environmental mitigation, etc.

Any of the systems and methods disclosed herein can be carried out (e.g., entirely or partially) on a computer or other device comprising a processor (e.g., a desktop computer, a laptop computer, a tablet, a server, a smartphone, or some combination thereof). FIG. 9 illustrates a computer system 400 suitable for implementing one or more embodiments disclosed herein. The computer system 400 includes a processor 481 (which may be referred to as a central processor unit or CPU) that is in communication with memory devices including secondary storage 482, read only memory (ROM) 483, random access memory (RAM) 484, input/output (I/O) devices 485, and network connectivity devices 486. The processor 481 may be implemented as one or more CPU chips.

It is understood that by programming and/or loading executable instructions onto the computer system 400, at least one of the CPU 481, the RAM 484, and the ROM 483 are changed, transforming the computer system 400 in part into a particular machine or apparatus having the novel functionality taught by the present disclosure. Thus, the RAM 484 and/or the ROM 483 may comprise a non-transitory machine-readable (or computer-readable) medium that may include instructions (which may be referred to herein as machine-readable instructions) that are executable by CPU 481 to provide functionality to computing system 400. Thus, in some embodiments, a machine-readable instructions stored on a memory may be executed on a processor, so as to configured the processor to carry out some or all of the features of the methods described herein (e.g., method 10).

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 400 is turned on or booted, the CPU 481 may execute a computer program or application. For example, the CPU 481 may execute software or firmware stored in the ROM 483 or stored in the RAM 484. In some cases, on boot and/or when the application is initiated, the CPU 481 may copy the application or portions of the application from the secondary storage 482 to the RAM 484 or to memory space within the CPU 381 itself, and the CPU 481 may then execute instructions of which the application is comprised. In some cases, the CPU 481 may copy the application or portions of the application from memory accessed via the network connectivity devices 486 or via the I/O devices 485 to the RAM 484 or to memory space within the CPU 481, and the CPU 481 may then execute instructions of which the application is comprised. During execution, an application may load instructions into the CPU 481, for example load some of the instructions of the application into a cache of the CPU 481. In some contexts, an application that is executed may be said to configure the CPU 481 to do something, e.g., to configure the CPU 481 to perform the function or functions promoted by the subject application. When the CPU 481 is configured in this way by the application, the CPU 481 becomes a specific purpose computer or a specific purpose machine.

The secondary storage 482 is typically comprised of one or more disk drives or tape drives and is used for non-volatile storage of data and as an over-flow data storage device if RAM 484 is not large enough to hold all working data. Secondary storage 482 may be used to store programs which are loaded into RAM 484 when such programs are selected for execution. The ROM 483 is used to store instructions and perhaps data which are read during program execution. ROM 483 is a non-volatile memory device which typically has a small memory capacity relative to the larger memory capacity of secondary storage 482. The RAM 484 is used to store volatile data and perhaps to store instructions. Access to both ROM 483 and RAM 484 is typically faster than to secondary storage 482. The secondary storage 482, the RAM 484, and/or the ROM 483 may be referred to in some contexts as computer readable storage media and/or non-transitory computer readable media.

I/O devices 485 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 486 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 486 may enable the processor 481 to communicate with the Internet or one or more intranets. With such a network connection, it is contemplated that the processor 481 might receive information from the network, or might output information to the network (e.g., to an event database) in the course of performing the methods described herein. Such information, which is often represented as a sequence of instructions to be executed using processor 481, may be received from and outputted to the network, for example, in the form of a computer data signal embodied in a carrier wave.

Such information, which may include data or instructions to be executed using processor 481 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 481 executes instructions, codes, computer programs, scripts which it accesses from hard disk, floppy disk, optical disk (these various disk based systems may all be considered secondary storage 482), flash drive, ROM 483, RAM 484, or the network connectivity devices 486. While only one processor 481 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 482, for example, hard drives, floppy disks, optical disks, and/or other device, the ROM 483, and/or the RAM 484 may be referred to in some contexts as non-transitory instructions and/or non-transitory information.

In an embodiment, the computer system 400 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 400 to provide the functionality of a number of servers that is not directly bound to the number of computers in the computer system 400. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 400, at least portions of the contents of the computer program product to the secondary storage 482, to the ROM 483, to the RAM 484, and/or to other non-volatile memory and volatile memory of the computer system 400. The processor 481 may process the executable instructions and/or data structures in part by directly accessing the computer program product, for example by reading from a CD-ROM disk inserted into a disk drive peripheral of the computer system 400. Alternatively, the processor 481 may process the executable instructions and/or data structures by remotely accessing the computer program product, for example by downloading the executable instructions and/or data structures from a remote server through the network connectivity devices 486. The computer program product may comprise instructions that promote the loading and/or copying of data, data structures, files, and/or executable instructions to the secondary storage 482, to the ROM 483, to the RAM 484, and/or to other non-volatile memory and volatile memory of the computer system 400.

In some contexts, the secondary storage 482, the ROM 483, and the RAM 484 may be referred to as a non-transitory computer readable medium or a computer readable storage media. A dynamic RAM embodiment of the RAM 484, likewise, may be referred to as a non-transitory computer readable medium in that while the dynamic RAM receives electrical power and is operated in accordance with its design, for example during a period of time during which the computer system 400 is turned on and operational, the dynamic RAM stores information that is written to it. Similarly, the processor 481 may comprise an internal RAM, an internal ROM, a cache memory, and/or other internal non-transitory storage blocks, sections, or components that may be referred to in some contexts as non-transitory computer readable media or computer readable storage media.

The discussion above is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion above and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, when used herein (including in the claims), the words “about,” “generally,” “substantially,” “approximately,” and the like mean within a range of plus or minus 10%.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for modeling fluid flow within a subterranean formation, the method comprising:
(a) receiving a three-dimensional (3D) image of rock from the subterranean formation;
(b) defining a chemical system for the subterranean formation, wherein the chemical system comprises a plurality of chemical reactions within the subterranean formation;
(c) determining a concentration change within the subterranean formation over time due to solute transport and the chemical reactions of the chemical system;
(d) determining a change in pore space within the subterranean formation; and
(e) determining an updated concentration within the subterranean formation as a result of the concentration change and the change in pore space.

2. The method of claim 1, further comprising:
(f) after (d) and before (e), determining a porosity change within the subterranean formation based on the concentration change and the change in pore space; and
(g) if the porosity change is greater than a threshold, then proceeding to (e) and if the porosity change is equal to or below the threshold, then repeating (c).

3. The method of claim 1, wherein the 3D image comprises a plurality of two-dimensional (2D) slices arranged along an axis of the rock.

4. The method of claim 3, further comprising identifying pore space and solid phase space in the rock using the 3D image.

5. The method of claim 1, further comprising determining a 3D distribution of pressure and fluid flow velocity within the subterranean formation before (c), (d), and (e).

6. The method of claim 1, wherein the chemical reactions comprise chemical reactions that occur at a solid/fluid interface within the subterranean formation.

7. The method of claim 1, wherein (c) comprises determining the concentration changes within the subterranean formation using the following equation:
$$\frac{\partial {C}_{k}}{\partial t} = - ( u \cdot ∇ ) {C}_{k} + ∇ \cdot ( D \cdot ∇ {C}_{k} ) + {Σ}_{m} {A}_{m} {l}_{m} ,$$
wherein Cₖ is a concentration of the particular solute component (k), ∇ is a gradient of the concentration of the solute component (k) within the subterranean formation, t is time, u is flow rate, and D is a diffusion coefficient, Aₘ is a surface area of the solid/mineral phase available for reaction, and Iₘ is a mineral reaction rate.

8. The method of claim 1, wherein (d) comprises determining pore space changes in the subterranean formation due to dissolution and precipitation.

9. The method of claim 8, wherein (d) comprises:
(d1) determining a saturation index (SI) for each discretized space in the subterranean formation; and
(d2) for each discretized space in the subterranean formation, if the SI is greater than zero determining that precipitation is occurring, and if the SI is less than zero determining that dissolution is occurring.

10. The method of claim 9, wherein (d) comprises determining the SI for each discretized space using the following equation:
$$SI = log ( \frac{IAP}{{K}_{eq}} ) ,$$
wherein IAP is an ion product activity and K_{eq} is the equilibrium constant at a given temperature.

11. A system comprising:
a processor
a memory coupled to the processor, wherein the machine-readable instructions are stored on the memory, and wherein the machine-readable instructions, when executed on the processor, configure the processor to:
(a) receive a three-dimensional (3D) image of rock from the subterranean formation;
(b) define a chemical system for the subterranean formation, wherein the chemical system comprises a plurality of chemical reactions within the subterranean formation;
(c) determine a concentration change within the subterranean formation over time due to solute transport and the chemical reactions of the chemical system;
(d) determine a change in pore space within the subterranean formation; and
(e) determine an updated concentration within the subterranean formation as a result of the concentration change and the change in pore space.

12. The system of claim 11, wherein the machine-readable instructions, when executed on the processor, configure the processor to:
(f) after (d) and before (e), determine a porosity change within the subterranean formation based on the concentration change and the change in pore space; and
(g) if the porosity change is greater than a threshold, then proceed to (e) and if the porosity change is equal to or below the threshold, then repeat (c).

13. The system of claim 11, wherein the 3D image comprises a plurality of two-dimensional (2D) slices arranged along an axis of the rock.

14. The system of claim 13, wherein the machine-readable instructions, when executed on the processor, configure the processor to identify pore space and solid phase space in the rock using the 3D image.

15. The system of claim 11, wherein the machine-readable instructions, when executed on the processor, configure the processor to determine a 3D distribution of pressure and fluid flow velocity within the subterranean formation before (c), (d), and (e).

16. The system of claim 11, wherein the chemical reactions comprise chemical reactions that occur at a solid/fluid interface within the subterranean formation.

17. The system of claim 11, wherein (c) comprises determine the concentration changes within the subterranean formation using the following equation:
$$\frac{\partial {C}_{k}}{\partial t} = - ( u \cdot ∇ ) {C}_{k} + ∇ \cdot ( D \cdot ∇ {C}_{k} ) + {Σ}_{m} {A}_{m} {l}_{m}$$
wherein Cₖ is a concentration of the particular solute component (k), ∇ is a gradient of the concentration of the solute component (k) within the subterranean formation, t is time, u is flow rate, and D is a diffusion coefficient, Aₘ is a surface area of the solid/mineral phase available for reaction, and Iₘ is a mineral reaction rate.

18. The system of claim 11, wherein (d) comprises determining pore space changes in the subterranean formation due to dissolution and precipitation.

19. The system of claim 18, wherein (d) comprises:
(d1) determine a saturation index (SI) for each discretized space in the subterranean formation; and
(d2) for each discretized space in the subterranean formation, if the SI is greater than zero determine that precipitation is occurring, and if the SI is less than zero determine that dissolution is occurring.

20. The method of claim 19, wherein (d) comprises determine the SI for each discretized space using the following equation:
$$SI = log ( \frac{IAP}{{K}_{eq}} ) ,$$
wherein IAP is an ion product activity and Keg is the equilibrium constant at a given temperature.
